(19) United States
(12) Patent Application Publication
(10) Pub. No.: US 2016/0341417 A1
(43) Pub. Date: Nov. 24, 2016

(54) Illuminating Safety Glove

(71) Applicant: Luciano FREITAS, Lynchburg, VA (US)

(72) Inventor: Luciano FREITAS, Lynchburg, VA (US)

(21) Appl. No.: 14/718,409

(22) Filed: May 21, 2015

(51) Int. Cl. F21V 33/00; F21V 23/02; F21V 23/04; A41D 13/01; A41D 19/00

(52) U.S. Cl. CPC F21V 33/0076; A41D 13/01; A41D 19/0024; F21V 23/04; F21V 23/023; F21V 23/0471; F21V 23/0492; F21Y 2101/02

(57) ABSTRACT

A safety glove comprising has an interior surface and an exterior surface, a light source attached to the exterior surface of the glove, a power source to illuminate the light source and an activation switch positioned on the glove such that the switch can be actuated with fingers of the same hand of the user wearing the glove.

### TECHNICAL FIELD

The present invention relates to a safety glove for security, safety and in poorly lit or dark conditions.

### BACKGROUND

Police officers are called upon frequently to direct traffic and respond to emergencies under a wide variety of conditions. Directing traffic can be very dangerous because motorists are typically exposed to a number of distractions while driving. If not conducted properly, traffic control responsibilities can be dangerous or fatal to an officer.

Proper safety equipment for daylight traffic control includes a highly reflective traffic vest, whistle, and white or highly visible gloves. Police typically also are issued radios, a firearm and other equipment. Traffic control at night should also include a flashlight with traffic wand attached. The wand typically has a red color to get the attention of motorists.

Other traffic control aids for night time use includes equipment such as a traffic signal stick has a number of LEDs mounted inside the signal stick and can be used for direction of cars or for traffic control by repeatedly turning the LEDs on and off or continuously emitting a red signal.

Conventional traffic signal sticks and flashlights with wands can be at night in order to facilitate a traffic flow or to inform the signal clearly and for the purpose of sending a signal for safety of workers or for traffic control purposes. However, the officer no longer has a free hand since he must hold the signal stick or flashlight. Therefore, a need exists for a new and improved safety glove that can be used for providing hands-free traffic control. Moreover, a need exists for an integrated or automated approach to the use of all safety equipment under emergency conditions.

### SUMMARY OF THE INVENTION

Safety gloves are desirable for providing a source of light and for traffic control under poorly lit or dark conditions. The gloves are particularly useful when the use of both hands is required, eliminating the possibility of one hand holding a light source such as a flashlight. The person wearing the gloves can be seen more clearly from a distance during periods of low visibility, enhancing safety.

The present invention includes a glove with a built-in light source, power supply and switch for turning the light source on and off. The light source may be colored and may use flashing or other patterns.

The invention may also include additional light sources attached to the glove. The switch may take the form of a pushbutton on/off switch enclosed within the interior of the thumb of the glove. The light source may comprise a light emitting diode inserted into a socket which is further attached to a battery case and enclosed battery via wires.

In another embodiment, electroluminescent wire (EL wire) is used instead of the LEDs to produce an unbroken line of visible light.

Numerous objects, features and advantages of the present invention will be apparent to those of ordinary skill in the art upon a reading of the following detailed description and embodiments when taken in conjunction with the accompanying drawings. In this respect, it is understood that the invention is not limited in its application to the details of construction and to the arrangements of the components set forth in the following description or illustrated in the drawings. It is to be understood that the phraseology and terminology employed herein are for the purpose of descriptions and should not be regarded as limiting.

As such, those skilled in the art will appreciate that the conception may be the basis for the design of other structures, methods and systems for carrying out the several purposes of the present invention. The claims should be regarded as including such equivalent constructions insofar as they do not depart from the spirit and scope of the present invention. It is therefore an object of the present invention to provide a new and improved safety glove.

For a better understanding of the invention and its operating advantages, reference should be made to the accompanying drawings which use numerical identifiers that correspond to features in the detailed description.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a rear view (back of hand) of the safety glove;

FIG. 2 is a front view (palm of hand) of the safety glove;

FIGS. 3 and 4 show another embodiment of A safety glove;

FIG. 5 shows still another embodiment of A safety glove;

FIGS. 6 and 7 show a control circuit and schematic plan of the embodiment of FIG. 5, respectively; and

FIG. 8 shows another embodiment that links a body camera, police radio and firearm sensors to the safety glove.

The same reference numerals refer to the same parts throughout the various figures.

### DETAILED DESCRIPTION OF THE CURRENT EMBODIMENT

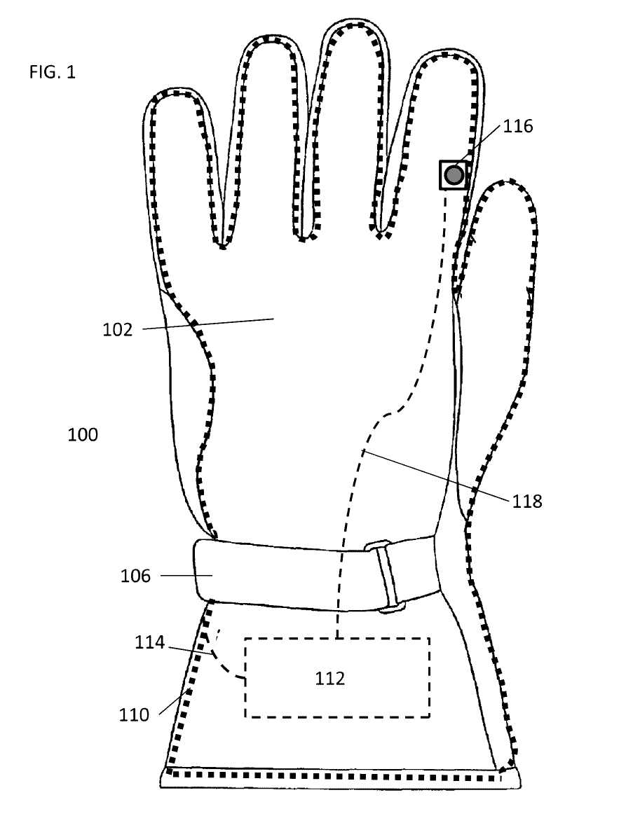

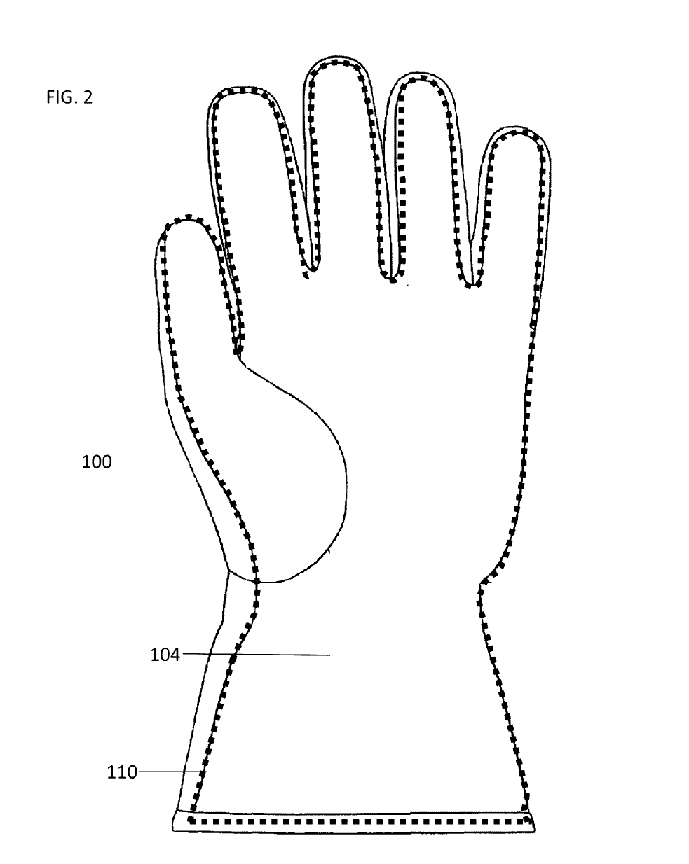

FIGS. 1 and 2 show an embodiment of a glove 100 having lighting control. A view of the back 102 of the glove is shown in FIG. 1 and the front 104 of the glove is shown in FIG. 2. The glove 100 can be made of made of a durable and flexible material that protects the user's hand while allowing mobility. In some embodiments, the glove 10 may includes a closure strap on the wrist section around the user's wrist. The strap is held in place against the surface of the glove by a hook and loop closure.

In the first embodiment, the glove 100 includes a series of LEDs 110 around the perimeter of the glove 100. As shown in the first embodiment, the heavy dashed lines represent the series of LEDs 110.

The lighting is powered by batteries in a battery compartment 112. The power may be from standard or rechargeable batteries.

A power wire 114 provides energy from the batteries to the LEDs 110. The power wire is shown as a dashed line since it is concealed between an inner lining and the shell of the glove 100.

A lighting control switch 116 is positioned on the top of the index finger such that it can be operated by the thumb. The control switch 116 is connected to the batteries by a control wire 118. The control switch 116 may use a push button for operation.

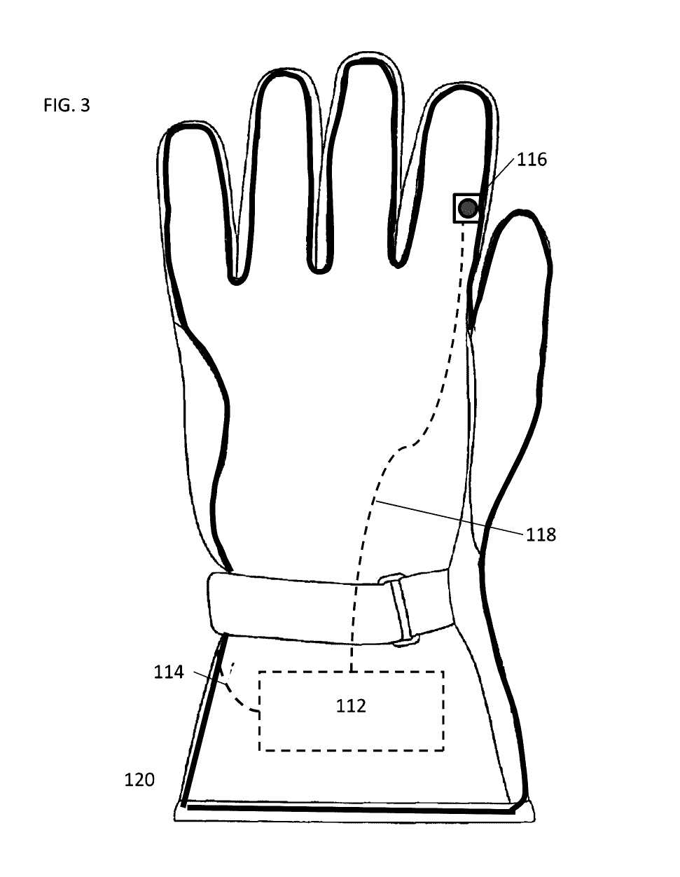

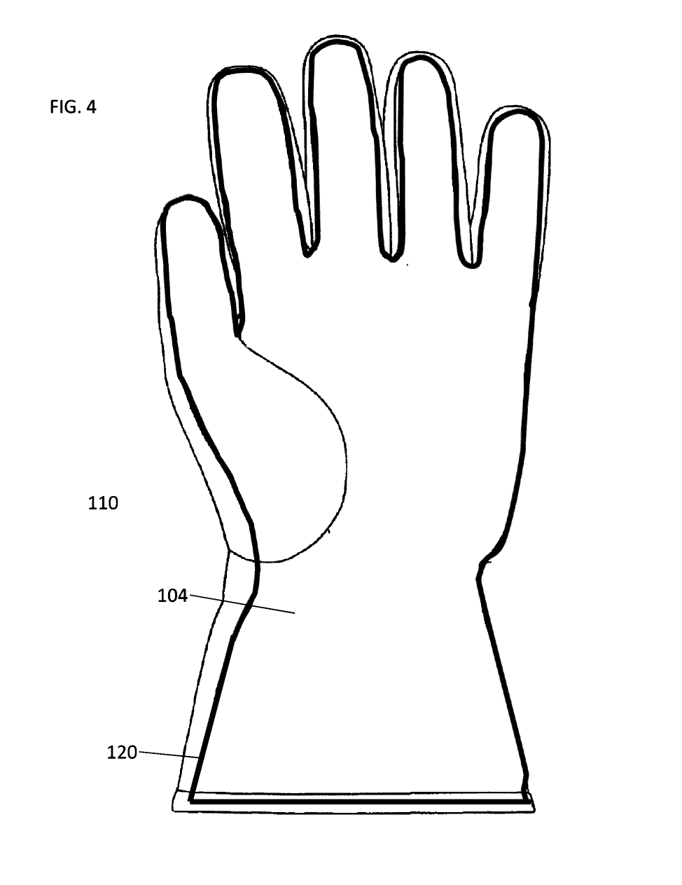

Referring to FIGS. 3 and 4, an electroluminescent wire (EL wire) 120 can be used instead of the LEDs 110. The EL wire 120 is a PVC sleeve with thin copper wire coated in a phosphor which glows when an alternating current is applied to it. The EL wire 120 produces an unbroken line of visible light. EL wire sequencer (not shown) can flash the EL wire in sequential patterns or a constant-on mode, blink or strobe modes.

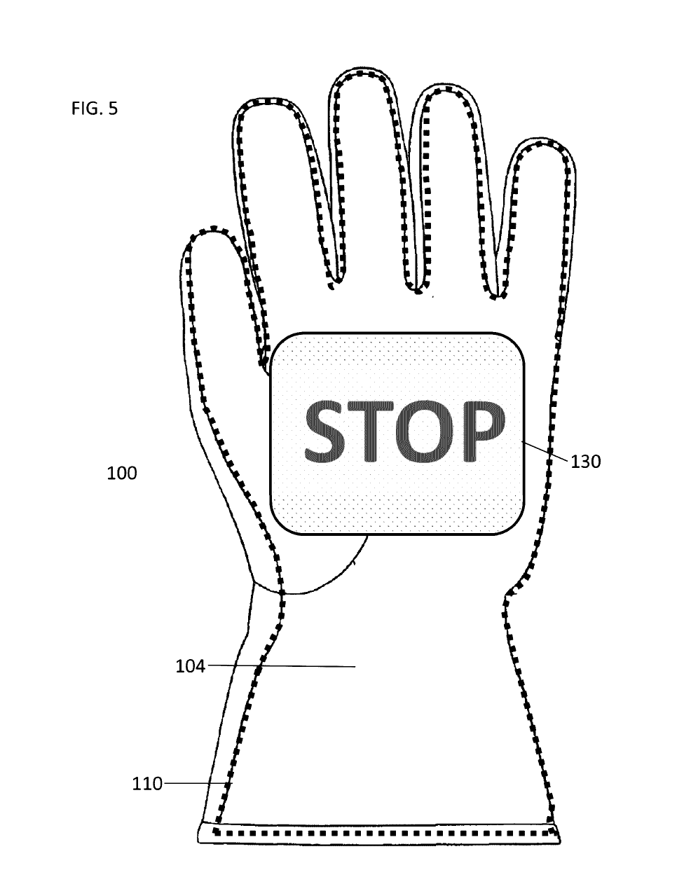

Referring to FIG. 5, a large illuminated area may be activated in response to a hand gesture. For example, in FIG. 5 the gesture is for a motorist to stop, so an illuminated area with the word STOP is visible.

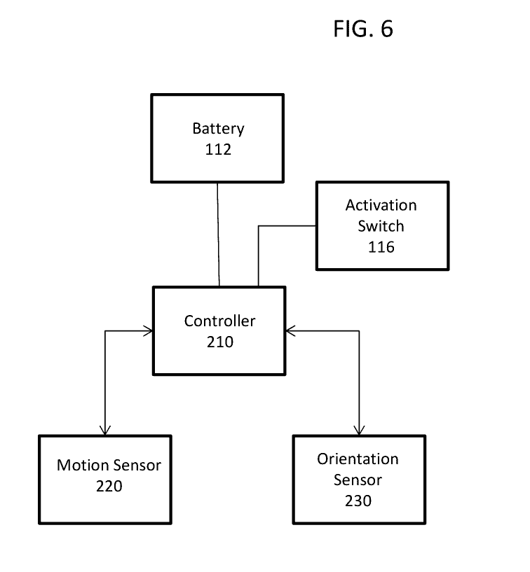

FIG. 6 shows a block diagram of an embodiment of a sensor unit 200 to respond to gestures. The sensor unit 200 may include a controller 210, a motion sensor 220, and an orientation sensor 230. As an example, the motion sensor 220 may be a three-axis accelerometer for providing linear and rotational motion information. The orientation sensor 230 may be a three-axis gyroscope to provide rotation motion information about the user's hand.

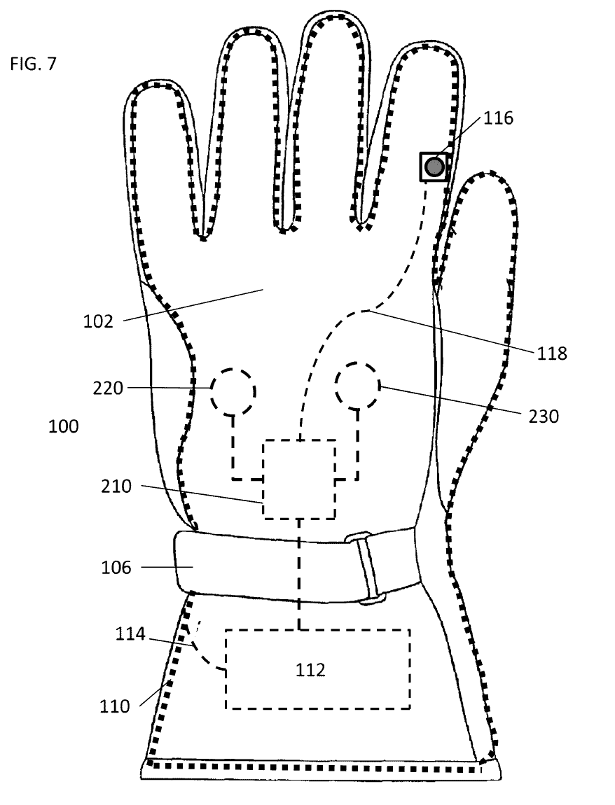

FIG. 7 shows the sensor unit 200 utilized in the safety glove. The sensor controller 210, motion sensor 220, and orientation sensor 230 are positioned between a shell and lining of the glove and are thus shown in dashed lines. The controller 210 utilizes the same battery power 112 and activation switch 116 used for the illumination circuitry.

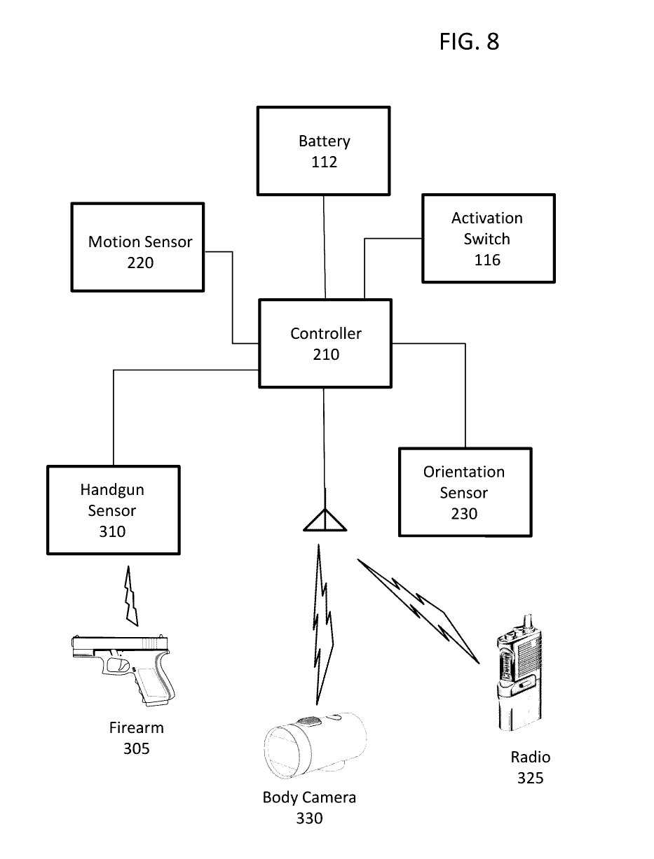

Referring to FIG. 8, on another embodiment the glove can be used to monitor to the hand position of the office with respect to his or her firearm 305. The glove includes a first sensor assembly 310 that communicates with a second sensor assembly 320 on the firearm. The controller 210 communicates with other devices, such as, for example, the officer's radio 325 and a body camera 330.

Generally, the sensor system (310, 320) may detect when the hand of the firearm is grasped by the handle. Another sensor of the sensor system may detect whether the firearm is removed from a holster. Still another sensor may be used to detect when the officer's hand is on the trigger or in the firing position. Another sensor may be used to detect whether one or more shot is fired.

The second sensor assembly 320 located on the firearm may be battery operated. The sensors of the sensor assemblies (310, 320) can assume a wide variety of forms and may not be identical. For example, the sensors on the handle may be an array of sensors to detect hand position and the shot detection may be an audio detection sensor. As another example, some sensor types can be equally e-field sensors, motion sensors, proximity sensors, pressure switches, etc.

The sensors can be used to send an alert that the officer needs assistance. For example, if the sensor system (310, 320) detects that the officer has his removed his firearm from the holster, the controller sends a panic signal through the officer's radio. As another feature, the hand position on the firearm may trigger a live feed from a body camera to a dispatcher. During the event, the hand position information can be recorded in conjunction with the video and audio on the body camera. Thus, accurate real-time information can be conveyed to the police dispatcher during an emergency event.

The method can include detecting a hand position on the firearm, linking the glove to the police radio, sending an alert signal from the controller to the police radio, instructing the police radio to send an alert to the dispatch, linking the glove and to the police radio and a body camera, instructing the police radio to send a live feed from the body camera, recording the hand position during while the live feed is being sent.

While a current embodiment of the light-emitting glove has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, the shell of the glove can be made of any suitable sturdy and flexible material such rubber, leather, cloth or vinyl.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A safety glove comprising:
a glove having an interior surface and an exterior surface;
a light source attached to the exterior surface of the glove;
a power source to illuminate the light source; and
an activation switch positioned on the glove such that the switch can be actuated with fingers of the same hand of the user wearing the glove.

2. The safety glove of claim 1, wherein the glove further comprises a shell and a liner inside the shell.

3. The safety glove as defined in claim 1, wherein the glove further comprises an exterior layer and an interior layer positioned inside the exterior layer.

4. The safety glove of claim 3, wherein the exterior layer comprises leather, cloth, rubber, and vinyl.

5. The safety glove of claim 1, wherein the light source comprises a series of light emitting diodes.

6. The safety glove of claim 1, wherein the light source comprises a series of light emitting diodes.

7. The safety glove of claim 1, wherein the power source comprises a battery case enclosed within a battery case.

8. The safety glove of claim 1, wherein the activation switch comprises multimode switch to turn the light on and off and to actuate continuous light, blinking light, and flashing light.

9. The safety glove of claim 1, further comprising:
a motion sensor to detect motion;
an orientation sensor to detect hand orientation;
a controller to process signals from the motion sensor and the orientation to actuate a particular light pattern based on a hand gesture.

10. The safety glove comprising of claim 1, wherein the activation switch is positioned on the glove such that the switch can be actuated by the thumb of the same hand of the user wearing the glove.

11. The safety glove comprising of claim 1, wherein the activation switch is located at a position corresponding to the dorsal portion of the wearer's index finger such that the switch can be actuated by the thumb of the same hand of the user wearing the glove.

12. The safety glove of claim 1, further comprising:
a proximity sensor to detect a hand position on a firearm;
a wireless communication link to a police radio; and
a controller to process signals from the proximity sensor and control the police radio;
wherein the controller instructs the police radio to send an alert signal based on a detected hand position on the firearm.

13. The safety glove of claim 12, further comprising:
a wireless link to a body camera;
wherein the controller instructs the police radio to live video feed from the body camera based on a detected hand position on the firearm.

14. The safety glove of claim 14, wherein detected hand position information is sent with the live video feed from the body camera.
